(19) United States
(12) Patent Application Publication
(10) Pub. No.: US 2008/0085710 A1
(43) Pub. Date: Apr. 10, 2008

(54) GAP SCHEDULING METHOD BASED ON MINIMUM GAP PATTERNS IN LONG TERM EVOLUTION SYSTEM

(75) Inventor: Basu Mallick PRATEEK, Byrasandra (IN)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/867,938

(22) Filed: Oct. 5, 2007

(30) Foreign Application Priority Data
Oct. 5, 2006 (IN) 1844/CHE/2006

(51) Int. Cl. H04Q 7/38

(52) U.S. Cl. 455/436

(57) ABSTRACT

The method herein concerns Long Term Evolution (LTE) whereby the measurement Gap Scheduling is decided between the UE and the E-UTRA network. The measurement Gap Scheduling will be required whenever the UE is measuring an Inter Layer LTE cell or an Inter RAT cell. The minimum Gap pattern based system depends on the priority cell list. Accordingly, the UE chooses a minimum gap pattern and indicates the same to the network, when the UE is required a gap pattern. The network takes the UE recommendation and approves the same or suggests a proper Gap Mode. Also disclosed is the use of Blind Handovers in the LTE system. This is based on a Cell Priority list. The most prioritized cell is chosen for Blind HO, in order to improve the overall cell load/schedule condition.

### PRIORITY

This application claims priority under 35 U.S.C. §119 to an application entitled “UE suggested—N/w decided Gap Scheduling based on Minimum GP in LTE System”, filed in the Indian Patent Office on Oct. 5, 2006 and assigned Serial No. 1844/CHE/2006, the contents of which are incorporated herein by reference.

### BACKGROUND OF THE INVENTION

1. Field of the Invention

The present invention relates generally to the Long Term Evolution (LTE) system, and in particular, to Radio Resource Control (RRC) Mobility Protocol handovers and measurements in the LTE system.

2. Description of the Related Art

Gap-assisted and non-Gap assisted measurements are being actively researched with respect to the LTE system. It is well-known that a User Equipment (UE) requires gaps for the Inter measurements, which concern the Inter Layer cells and Inter Radio Access Technology (RAT) (Universal Terrestrial Radio Access (UTRA)/Global System for Mobile Communications (GSM) cells). Currently, however, in spite of the ongoing research there is no known method for accomplishing these measurements in the LTE system.

U.S. Pat. No. 6,845,238 issued to Muller discusses Inter-frequency measurement and handover for wireless communications. Muller indicates that the quality estimate can be utilized to trigger a change or switch of frequencies/systems, and that certain thresholds employed in the quality estimate-utilizing handovers provide hysteresis protection.

However, Muller does not provide a method for gap-assisted and non-gap assisted measurements in the LTE system, and there is no known disclosure of such a method in the prior art.

An LTE UE would require gaps to measure the Inter Layer and Inter RAT cells. From the ongoing discussions it can be concluded that a method is needed which can benefit from the known UE technology and which will allow the network to have the overall control. The current discussions have related to gap assisted and non-gap assisted measurements. A UE would require gaps to measure the Inter Layer and Inter RAT cells.

In the gap-assisted measurements, the discussions are ongoing to decide whether the requirement for gaps and subsequently the triggering of gap patterns will be performed at the network (n/w) or at the UE. Some research is exploring the possibility that such a gap schedule request comes from the UE itself, while other research is suggesting that the Gap Pattern (GP) should be indicated by the n/w. In the latter case, the decision to schedule gaps will depend on the UE measurements, which has the drawback of involving latency.

The UE should be involved as in following Use Cases:

UE inactivity—(UE DRX)—It may not be known whether the UE has already performed enough measurements on its own.

Bad signal area—the UE can carry out some, but not all, inter measurement in this situation.

In addition, conservative and wasteful allocation from the n/w may occur, and in the case of an anchoring eNode-B, there is no knowledge of UE capability. In such cases the decision to provide the GP to the UE without UE involvement would be a waste of resources.

On the other hand, if the UE decides the gap requirement it would not be involved in the bigger cell load picture. Though in this case all of the foregoing situations (i.e., use cases) can be fulfilled, it is possible for many UEs to request for the Gaps simultaneously. Thus, for the n/w it may not be possible to sustain the scheduling for all of the requesting UEs while meeting the Quality of Service (QOS) requirements.

Therefore, a method is needed which can benefit from the UE knowledge of the use cases, while simultaneously preventing overload of the n/w.

### SUMMARY OF THE INVENTION

Accordingly, the present invention has been made to solve the above-mentioned problems occurring in the prior art, and an aspect of the present invention is to provide a method for gap-assisted and non-gap assisted measurements in the LTE system.

An aspect of the present invention is to provide a method that benefits from the UE knowledge of the use cases, while simultaneously preventing overload of the n/w, and aims at being efficient in terms of latency requirements by involving minimum signaling.

In accordance with the present invention, there is provided a minimum gap pattern based, UE initiated, network controlled scheduling.

Further disclosed in the present invention is a cell priority listing for neighbor cell measurements for an improved handover success rate, as well as a blind Handover based on the cell priority list.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates the steps performed between the UE and the network in the gap assisted and non-gap assisted measurement method according to the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

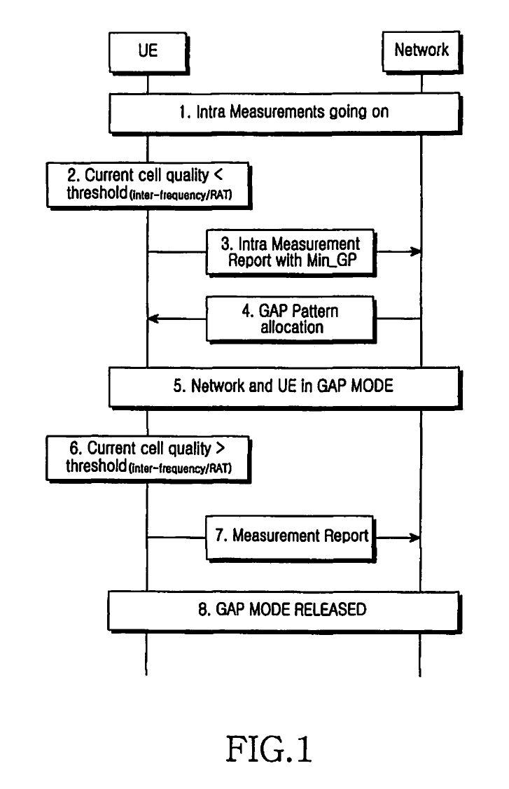

In FIG. 1, the UE is performing the intra frequency measurements (step1). The UE realizes that the present frequency drops below a threshold and that it needs to perform the inter frequency/RAT measurements (step2). The UE decides a gap pattern, that it indicates to the network as the best suited pattern. The UE take into consideration at least its priority for RAT, network topology, handover history and cell rank. After having decided on a gap pattern, the UE indicates the same to the network (step3). The network considers the UE request, and if the cell load and scheduler restrictions allow, the network allocates the same Gap pattern to the UE. However, if the gap pattern cannot be allocated to the UE for cell load or scheduling restrictions, the network allocates the next best match in terms of measurement performance to the UE.

Gap pattern allocation is indicated by the network in step 4. Then, the UE begins using the gap pattern after an activation time as indicated by the network in step4. At this time both the UE and the network are in the Gap Mode (step5). If the cell quality later exceeds a threshold, the UE need not continue the inter frequency/RAT measurement and hence may decide to abandon gaps. The UE, in this case, informs the network about the present cell quality (step7), and the network in turn will know that the UE no longer needs the gap pattern. Therefore the gap pattern is released (step8).

In order to support efficient mobility in any wireless cellular system, the UEs are required to identify and measure the relevant measurement quantities of neighbor cells and the serving cell. Such measurements for mobility are needed in various mobility functions such as Cell Selection and reselection, and handover decisions.

The present invention concerns the Inter frequency measurements. Neighbor cell measurements are considered inter-frequency measurements when the UE needs to re-tune its (Frequency synthesizer) receiver in order to carry out the measurements. This corresponds to when the neighbor cell is operating on a different carrier frequency than the current cell, or the same carrier frequency as the current cell, but the UE maximum bandwidth capability is smaller than the network system bandwidth and the UE is currently “camping” within a band so that the common channels of the target cell are outside the UE receiving bandwidth.

The inter frequency measurements could be made both on the present as well as on a different RAT, such as GSM EDGE RAT (GERAN), UMTS and LTE. In inter-frequency measurements, the network needs to be able to provide UpLink/DowLink (UL/DL) idle periods for the UE to perform necessary neighbor measurements. These idle UL/DL periods are called gaps. A set of gaps which are especially designed to facilitate the efficient measurement of a neighboring frequency is called a gap pattern, which includes gaps where the UE performs measurement of the neighboring frequency, and non-gaps where the UE performs the activity on the current frequency. There can be a number of gap patterns with different performance requirements. Both the UE and the network shall know which gap pattern is being used and they shall be synchronized.

While there are some situation when the UE can better identify what kind of gaps it requires to perform the inter measurements, the network controls the overall cell load.

Also, the scheduler at the network decides the UE traffic activity scheduling based on the incoming traffic in the downlink. Therefore, that which will control the gap pattern allocation between UE and the network needs to be decided. Due to the UE's knowledge of its own measurement requirements and the network's knowledge of cell load, it is optimal if the network and the UE participate in this decision, such that UE and the network will be involved in the control over the Gap Scheduling process.

The following are the steps involved in the scheduling of gaps, starting with the intra measurements that are required to find out the quality for the current cells. First, the UE receives Measurement Control from the n/w and performs Intra measurements. Second, Intra quality worsens, and third, the UE decides on a Min_GP to be used. This selection will be based on the UE's knowledge of its own condition (Use cases), as well as the Cell Priority list, which will be explained below.

The UE in its measurement report indicating bad intra quality will also indicate the Min_GP to network. This message in addition may contain the measurement report of all the inter cells already measured by the UE. The N/w can use this measurement report for an Immediate HandOver (HO) decision. The sending of the minimum gaps from the UE takes advantage of the UE's knowledge of its own situation, and at the same time, it does not ‘over burden’ the network. The min_gap is designed in such a manner that it allows the LTE UE to measure a minimum of Inter Cells. The minimum cell number could be decided by the network and should be a result of network optimization. This value can be at least 1 based on Cell-Load and scheduling condition. It can be dynamically changed and informed to the UE using the Broadcast Channel (BCH) or it can be kept static. The UE measures the cells based on a priority order. The priority of the cells will depend on such aspects as LTE Service Handover [4], Cell/network Topology, Previous History, Cell rank based on old measurements, and Performed measurements.

The UE chooses the min_GP based on the cells that it wishes to measure first, which will be decided by the cell priority list.

For a description of the above criteria and CPL please refer to the Cell Priority Criteria, given at the end of this section.

At the n/w side, in a first option, the n/w scheduler at periodic scheduling intervals such as every Transmission Time Interval (TTI) or multiple TTIs, performs the ‘Admission check’ for all the min_GPs and prepares a ‘lookup table’ for the next schedule period. Examples are min_GP1 OK, min_GP2 OK, min_GP3 NOK and min_GP4 OK.

Upon receiving a min_GP request, n/w uses the lookup table to indicate the UE-min_GP: OK/NOK.

In a second option, the N/w uses the Min_GP signaled from the UE to estimate the type of gap pattern for which the UE is searching. It can be used as an important parameter to decide on a proper Gap Pattern, so as to measure a greater number of inter cells.

When the requirement for gaps ceases, the UE can indicate the same to the n/w using some good CQI reports.

In either option 1 or option 2, the n/w will send the Gap Indication to the UE with an explicit message. Option 1 is less time consuming, and therefore provides less of a turnaround time to start the GAP assisted measurements.

In blind HO based on Cell Priority, if the priority ordering of cells above (point 4) yields successful results, i.e. the HO attempts lead to an increased HO success rate based on overall n/w experience, then the n/w may decide on a Blind HO. The concept is that between a pair of cells the n/w is reasonably confident that the HO can be performed without supporting measurements. The best cell according to the cell priority is a good candidate for Blind HO. If implemented successfully, this will lead to immediate HO that will be beneficial when the quality degrades sharply in the serving cells. This will also avoid a signaling overload.

Cell Priority List (CPL) can be given to the UE in measurement control message, or the common part of the CPL (criteria applicable to all the UEs in the cell) can be broadcasted. In the latter case the UEs apply the individual priority (e.g., cell rank, LTE service HO IE) and receive the exact CPL. A modified CPL can be indicated by the n/w in the message where it informs the UE about the GP allocated to it.

As to Service Handover in LTE, in UTRA the RAB ASSIGNMENT REQUEST contains a parameter called Service Handover. This parameter indicates a priority of HOs between UTRA and GSM cells. Service Handover in LTE indicates the preference between E-UTRA, UTRA and GSM cells.

Cell/network Topology indicates the affinity in terms of geographical location of two cells. For example, cells situated along a busy street will be more likely candidates for HO from one another than off-road cells.

Previous History indicates the successful HOs to the current cell and the source cell.

Cell rank is same as measurement based cell ranking in UTRA cells for the particular UE. It should be noted that none of the criterion is binding and is therefore implementation specific.

As to Performed measurements, the UE considers the measurements which it has already performed.

There are many advantages realized by the present invention. The UE is permitted to handle its actual requirements—‘Use Cases’ and the Network has the majority of overall control. Immediate HO is possible using the UE's ‘already measured’ Inter cell measurement report. Measuring better cells avoids complete n-cell measurements and the resulting successful HOs decreases the overall cell load condition.

Min_GP allocation using the lookup table by the n/w is less time consuming. Overall cell load decreases as a result of successful Hos, due to fewer required measurements.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method in a User Equipment (UE) requiring a gap pattern to perform inter frequency/Radio Access Technology (RAT) measurement, comprising:
selecting a minimum gap pattern out of an available set of minimum gap patterns, wherein the minimum gap pattern is an un-repeated representation of the actual available gap patterns.
